(19) United States
(12) Patent Application Publication
(10) Pub. No.: US 2007/0226086 A1
(43) Pub. Date: Sep. 27, 2007

(54) System and method for credit card lost-and-found notification

(76) Inventors: Brian Bauman, Austin, TX (US); Amanda J. Burton, Austin, TX (US); Michael P. Carlson, Austin, TX (US); Herman Rodriguez, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/373,872

(22) Filed: Mar. 10, 2006

(51) Int. Cl. G06Q 10/00

(52) U.S. Cl. 705/28

(57) ABSTRACT

A method, system, and computer-usable medium for sending a first notification message to a credit card agency alerting the credit card agency of a misplaced credit card, an identification of a credit card owner, and a location of the misplaced credit card; in response to receiving the first notification message, sending a second notification message to the credit card owner corresponding to the misplaced credit card; and in response to receiving the second notification message, specifying a procedure for returning the misplaced credit card to the credit card owner.

### BACKGROUND OF THE INVENTION

1. Technical Field

The present invention relates in general to the field of data processing systems. More specifically, the present invention relates to a system and method for credit card lost-and-found notification.

2. Description of the Related Art

The utilization of credit cards is nearly ubiquitous in today's world. Some examples of common credit card use include the payment of goods or services via phone or an online store. A credit card is commonly defined as a plastic card that includes a number and a coded magnetic stripe. The credit card, when signed, entitles its bearer to a revolving line of credit. The size and interest rate pertaining to the line of credit is commonly determined by the borrower's income and credit report. The use of credit cards began in the late 1940s when banks issued paper certificates that could be utilized like cash in local stores. The first real credit card was issued in 1951 by Franklin National Bank in New York.

If a credit card holder accidentally leaves his or her credit card at an establishment, or loses his or her card, the credit card holder must retrace his or her steps to determine the last known location of the credit card. Therefore, there is a need for a system and method addressing the above-mentioned limitation.

### SUMMARY OF THE INVENTION

The present invention includes a method, system, and computer-usable medium for sending a first notification message to a credit card agency alerting the credit card agency of a misplaced credit card, an identification of a credit card owner, and a location of the misplaced credit card; in response to receiving the first notification message, sending a second notification message to the credit card owner corresponding to the misplaced credit card; and in response to receiving the second notification message, specifying a procedure for returning the misplaced credit card to the credit card owner.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, wherein:

FIG. 1A is a block diagram illustrating an exemplary network in which a preferred embodiment of the present invention may be implemented;

FIG. 1B is a block diagram depicting an exemplary data processing system in which a preferred embodiment of the present invention may be implemented; and

FIG. 2 is a flowchart diagram illustrating an exemplary method for credit card lost-and-found notification according to a preferred embodiment of the present invention.

### DETAILED DESCRIPTION OF A PREFERRED EMBODIMENT

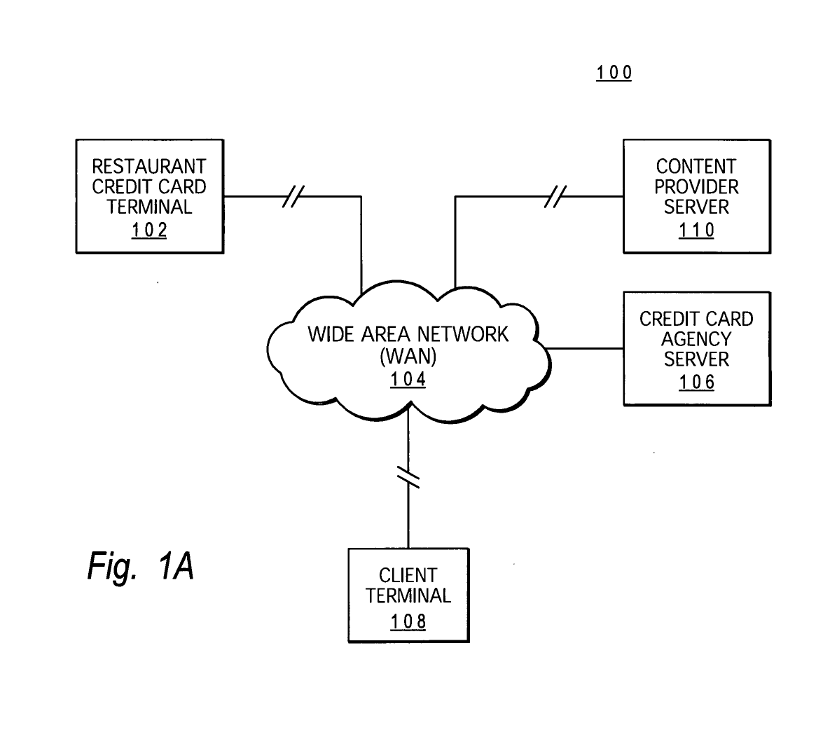

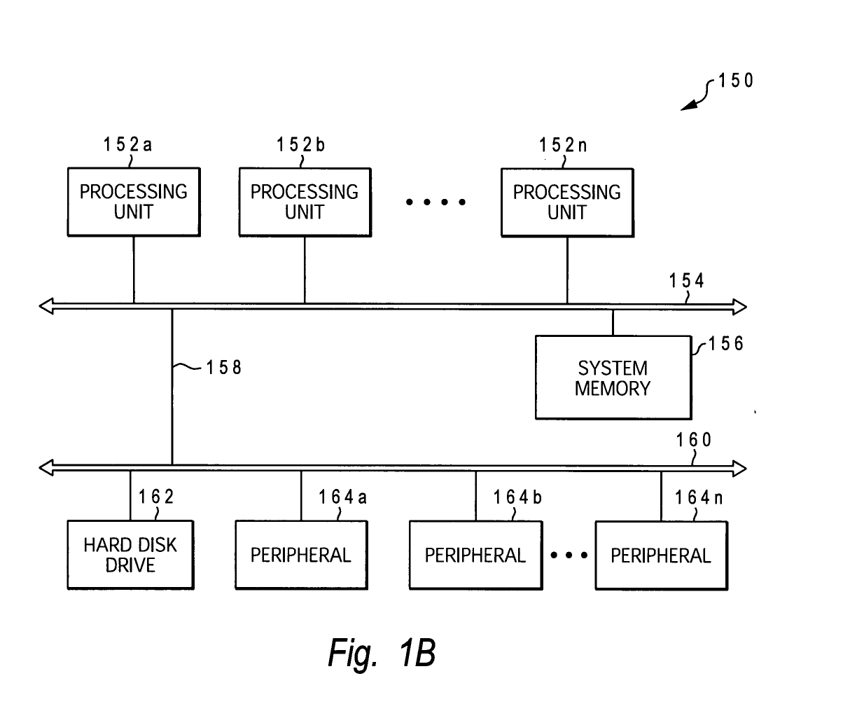

Referring now to the figures, and more specifically, referring now to FIG. 1A, there is illustrated a block diagram depicting an exemplary network 100 in which a preferred embodiment of the present invention may be implemented. As illustrated, network 100 includes a restaurant credit card terminal 102, wide-area network (WAN) 104, credit card agency server 106, and client terminal 108.

In a preferred embodiment of the present invention, network 100 provides a system in which a credit card owner may retrieve a credit card that was accidentally left at a restaurant after a meal. Restaurant credit card terminal 102 is preferably implemented as a computer interface that includes a magnetic card reader for gathering information from the magnetic stripe located on the back of the credit card.

Restaurant credit card terminal 102 is coupled to the other components of network 100 via wide-area network (WAN) 104, which is preferably implemented as the Internet. Credit card agency server 106 is preferably implemented as a computer server that includes at least one computer-readable medium that stores information regarding credit card transactions and credit card owner information.

Client terminal 108 is preferably implemented as a computer system, telephone, personal data assistant (PDA), or another other device capable of coupling to WAN 104 and receive messages from credit card agency server 106 about lost credit cards.

Referring now to FIG. 1B, there is depicted a block diagram illustrating an exemplary data processing system 150 in which a preferred embodiment of the present invention may be implemented. Those with skill in the art will appreciate that data processing system 150 may be utilized to implement restaurant credit card terminal 102, credit card agency server 106, client terminal 108, and content provider server 110.

As illustrated, data processing system 150 includes a collection of processing units 152a-n which are coupled by system interconnect 154. Also coupled to processing units 152a-n via system interconnect 154 is system memory 156. Mezzanine interconnect 158 couples system interconnect 154 with peripheral interconnect 160.

Those with skill in this art will appreciate that peripheral interconnect 160 may be implemented as a peripheral component interconnect (PCI), accelerated graphics port (AGP), or any other peripheral bus. Coupled to peripheral interconnect 160 is hard disk drive 162, which is utilized by data processing system 150 as a mass storage device. Also coupled to peripheral bus 160 is a collection of peripherals 164a-n.

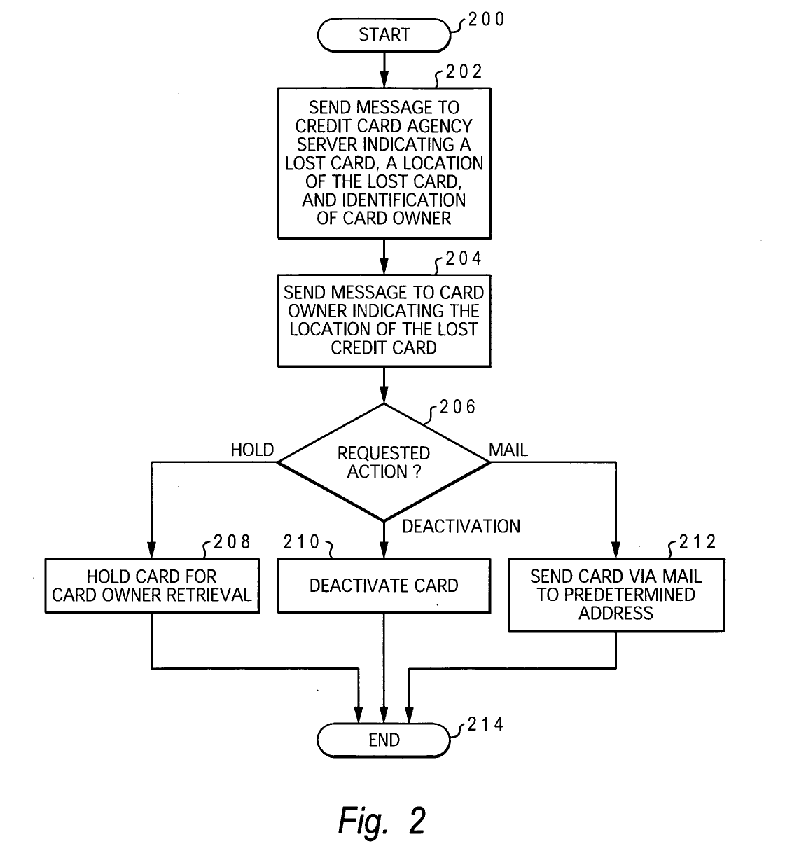

Those skilled in the art will appreciate that data processing system 150 can include many additional components not specifically illustrated in FIG. 1B. Because such additional components are not necessary for an understanding of the present invention, they are not illustrated in FIG. 2 or discussed further herein. It should also be understood, however, that the enhancements to data processing system 200 for credit card lost-and-found notification provided by the present invention are applicable to data processing systems of any system architecture and are in no way limited to the generalized multi-processor architecture or symmetric multi-processing (SMP) architecture illustrated in FIG. 1B.

With reference now to FIG. 2, there is illustrated a flowchart diagram illustrating an exemplary method for credit card lost-and-found notification according to a preferred embodiment of the present invention. For example, if a credit card owner accidentally leaves his credit card at a restaurant, the present invention provides a method of notifying the credit card owner of the location of the credit card.

As illustrated in steps 200-202, a first notification message is sent from restaurant card terminal 102 to credit card agency server 106 via WAN 104 that includes a location of the lost credit card and the identification of the credit card owner. In response to receiving the first notification message, credit card agency server 106 sends a second notification message to client terminal 108 via WAN 104 (step 204). The second notification message includes an indication that a credit card belonging to the credit card owner has been reported lost and the location of the lost credit card. Preferably, this second notification message may be an automated message sent via e-mail or phone. As previously discussed, client terminal 108 may be implemented as any device capable of connection to WAN 104, including, but not limited to, a phone, a desktop or laptop computer, a personal data assistant (PDA), etc.

After receiving the second notification message, the credit card owner may determine the requested action to be performed on the missing credit card. For example, the restaurant may receive a message from the card owner via client terminal 108 instructing the restaurant employees to hold the credit card for the credit card owner to physically retrieve the credit card (step 208). For security purposes and to discourage unauthorized use of the credit card, the credit card owner may send a message via client terminal 108 to credit card agency server 106 to deactivate the missing credit card (step 210). Also, the credit card owner may send a message via client terminal 108 instructing the restaurant employees to send the missing credit card to the credit card holder via a predetermined or provided address. (step 212). As illustrated, the process ends at step 214.

As discussed, the present invention includes a method, system, and computer-usable medium for sending a first notification message to a credit card agency alerting the credit card agency of a misplaced credit card, an identification of a credit card owner, and a location of the misplaced credit card; in response to receiving the first notification message, sending a second notification message to the credit card owner corresponding to the misplaced credit card; and in response to receiving the second notification message, specifying a procedure for returning the misplaced credit card to the credit card owner.

It should be understood that at least some aspects of the present invention may be alternatively be implemented in a computer-usable medium that contains a program product. Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD-ROM, optical media), system memory such as, but not limited to Random Access Memory (RAM), and communication media, such as computer and telephone networks, including Ethernet, the Internet, wireless networks, and like network systems. It should be understood, therefore, that such signal-bearing media when carrying or encoding computer-readable instructions that direct method functions in the present invention, represent alternative embodiments of the present invention. Further, it is understood that the present invention may be implemented by a system having means in the form of hardware, software, or a combination of software and hardware as described herein or their equivalent.

While the invention has been particularly shown and described with reference to a preferred embodiment, it will be understood by those skilled in the art that various changes in form and detail may be made therein without departing from the spirit and scope of the invention.

What is claimed is:

1. A method of notifying a credit card owner of a misplaced credit card comprising:
sending a first notification message to a credit card agency alerting said credit card agency of a misplaced credit card, an identification of a credit card owner, and a location of said misplaced credit card;
in response to receiving said first notification message, sending a second notification message to said credit card owner corresponding to said misplaced credit card; and
in response to receiving said second notification message, specifying a procedure for returning said misplaced credit card to said credit card owner.

2. The method according to claim 1, wherein said second notification message is an automated e-mail message.

3. The method according to claim 1, wherein said second notification message is an automated phone message.

4. The method according to claim 1, wherein said procedure for returning further includes:
indicating said misplaced credit card is to be held at said location of said misplaced credit card to enable said credit card owner to retrieve said misplaced credit card.

5. The method according to claim 1, wherein said procedure for returning further includes:
mailing said misplaced credit card to said credit card owner utilizing a predetermined address.

6. The method according to claim 1, further comprising:
in response to receiving said second notification message, deactivating said misplaced credit card to prevent unauthorized use of said misplaced credit card.

7. A system comprising:
a processor;
a data bus coupled to said processor;
a memory coupled to said data bus; and
a computer-usable medium embodying computer program code, said computer program code comprising instructions executable by said processor and configured for:
sending a first notification message to a credit card agency alerting said credit card agency of a misplaced credit card, an identification of a credit card owner, and a location of said misplaced credit card;
in response to receiving said first notification message, sending a second notification message to said credit card owner corresponding to said misplaced credit card; and
in response to receiving said second notification message, specifying a procedure for returning said misplaced credit card to said credit card owner.

8. The system according to claim 7, wherein said second notification message is an automated e-mail message.

9. The system according to claim 7, wherein said second notification message is an automated phone message.

10. The system according to claim 7, wherein said instructions for said procedure for returning further includes instructions configured for:
indicating said misplaced credit card is to be held at said location of said misplaced credit card to enable said credit card owner to retrieve said misplaced credit card.

11. The system according to claim 7, wherein said instructions for said procedure for returning further includes instructions configured for:
mailing said misplaced credit card to said credit card owner utilizing a predetermined address.

12. The system according to claim 7, wherein said instructions are further configured for:
in response to receiving said second notification message, deactivating said misplaced credit card to prevent unauthorized use of said misplaced credit card.

13. A computer-usable medium embodying computer program code, said computer program code comprising computer executable instructions configured for:
sending a first notification message to a credit card agency alerting said credit card agency of a misplaced credit card, an identification of a credit card owner, and a location of said misplaced credit card;
in response to receiving said first notification message, sending a second notification message to said credit card owner corresponding to said misplaced credit card; and
in response to receiving said second notification message, specifying a procedure for returning said misplaced credit card to said credit card owner.

14. The computer-usable medium according to claim 13, wherein said second notification message is an automated e-mail message.

15. The computer-usable medium according to claim 13, wherein said second notification message is an automated phone message.

16. The computer-usable medium according to claim 13, wherein said computer executable instructions for said procedure for returning further includes computer executable instructions configured for:
indicating said misplaced credit card is to be held at said location of said misplaced credit card to enable said credit card owner to retrieve said misplaced credit card.

17. The computer-usable medium according to claim 13, wherein said computer executable instructions for said procedure for returning further includes computer executable instructions configured for:
mailing said misplaced credit card to said credit card owner utilizing a predetermined address.

18. The computer-usable medium according to claim 13, wherein said embodied computer program code further comprises computer executable instructions configured for:
in response to receiving said second notification message, deactivating said misplaced credit card to prevent unauthorized use of said misplaced credit card.
